(19) United States
(12) Patent Application Publication
(10) Pub. No.: US 2021/0312578 A1
(43) Pub. Date: Oct. 7, 2021

(54) SYSTEMS AND METHODS TO SELECT PARTICIPANTS IN A PROGRAM TO SUSTAINABLY EXIT POVERTY

(71) Applicant: Ten by Three, St. Louis, MO (US)

(72) Inventors: Theresa Carrington, Edwardsville, IL (US); Charles Grady, St. Louis, MO (US); Timothy J. Ernst, St. Louis, MO (US)

(21) Appl. No.: 17/354,493

(22) Filed: Jun. 22, 2021

Related U.S. Application Data
(63) Continuation-in-part of application No. 14/138,460, filed on Dec. 23, 2013, now abandoned.

(51) Int. Cl. G06Q 50/22; G06Q 30/02; G06Q 40/02; G06N 20/00; G06N 5/02

(52) U.S. Cl. CPC G06Q 50/22; G06Q 30/0201; G06N 5/02; G06Q 40/02; G06N 20/00; G06Q 30/0203

(57) ABSTRACT

A computer-implemented method for selecting participants from an applicant pool to participate in a program to exit poverty is described. The method implemented using a computing device in communication with a memory. The method includes storing a plurality of questions to ask each applicant from a pool of applicants, storing a plurality of ratings based on historical data wherein each rating is associated with each of one or more potential answers for each question of the plurality of questions, compiling by the computing device one or more scores for the applicant based on the applicant's answers to the plurality of questions and the plurality of ratings, calculating by the computing device the applicant's overall score based on the one or more scores, determining the applicant's ranking in comparison to the pool of applicants, and outputting the rankings of the applicants.

### CROSS REFERENCE TO RELATED APPLICATIONS

This application is a continuation in part of U.S. patent application Ser. No. 14/138,460, filed Dec. 23, 2013, which is incorporated by reference herein in its entirety.

### BACKGROUND OF THE DISCLOSURE

The field of the disclosure relates generally to selecting applicants for participation in a program, and more particularly to a selection process to facilitate choosing participants who are most likely to succeed at a program that enables such participants to earn a wage and work their way out of poverty.

Numerous organizations have established programs that provide assistance for those living in poverty. The World Bank defines poverty as living below the International Poverty Line. The International Poverty Line was adjusted in 2015 from US$1.25 a day to US$1.90 a day. While many programs do provide at least some temporary relief for some people living in poverty, such programs are not necessarily focused on providing assistance in a manner that can assist individuals living in poverty to sustainably exit poverty. Rather, such programs address immediate needs such as providing food, water and shelter, and the relief provided is temporary, e.g., limited resources are available under such programs. While there certainly is a need for programs that provide such assistance, these programs are not necessarily focused on assisting individuals in sustainably exiting poverty.

In addition, many known programs generally focus on providing aid to all those living in poverty in a particular geographic area or on a specific circumstance at least partly attributable to causing poverty. As a result, aid may be provided across a broad population within the selected geography or a broad population exposed to the selected circumstance. Within such a broad population, at least some of those receiving aid are not willing, are not prepared, or lack an understanding of how to use the aid as a support mechanism out of poverty. Such aid can even be subject to abuse.

### BRIEF DESCRIPTION OF THE DISCLOSURE

In one aspect, a computer-implemented method for selecting participants from an applicant pool to participate in a program to exit poverty is described. The method is implemented using a computer device in communication with a memory. The method includes storing in the memory a plurality of questions to ask each applicant from a pool of applicants, storing in the memory a plurality of ratings based on historical data wherein each rating is associated with each of one or more potential answers for each question of the plurality of questions, compiling by the computing device one or more scores for the applicant based on the applicant's answers to the plurality of questions and the plurality of ratings, calculating by the computing device the applicant's overall score based on the one or more scores, determining the applicant's ranking in comparison to the pool of applicants, and outputting the rankings of the applicants.

In another aspect, a computing device for selecting participants from an applicant pool to participate in a program to exit poverty is described. The computing device includes a processor communicatively coupled to a memory device. The computing device is configured to store a plurality of questions to ask each applicant from a pool of applicants, store a plurality of ratings based on historical data wherein each rating is associated with each of one or more potential answers for each question of the plurality of questions, compile one or more scores for the applicant based on the applicant's answers to the plurality of questions and the plurality of ratings, calculate the applicant's overall score based on the one or more scores, determine the applicant's ranking in comparison to the pool of applicants, and output the rankings of the applicants.

In yet another aspect, a computer-readable storage medium having computer-executable instructions embodied thereon is described. When executed by a computing device having at least one processor coupled to a memory device, the computer-executable instructions cause the processor to store a plurality of questions to ask each applicant from a pool of applicants, store a plurality of ratings based on historical data wherein each rating is associated with each of one or more potential answers for each question of the plurality of questions, compile one or more scores for the applicant based on the applicant's answers to the plurality of questions and the plurality of ratings, calculate the applicant's overall score based on the one or more scores, determine the applicant's ranking in comparison to the pool of applicants, and output the rankings of the applicants.

### BRIEF DESCRIPTION OF THE DRAWINGS

FIGS. 1-5 show example embodiments of the methods and systems described herein.

FIG. 1 is a block diagram of an exemplary computing device.

FIG. 2 is a block diagram of the process of interviewing an applicant.

FIG. 3 is a high-level overview flowchart of the process for selecting applicants in accordance with one embodiment of this disclosure.

FIG. 4 is a detailed flowchart of the interaction between the AS computing device and the examiner during the selection process.

FIG. 5 is a detailed flowchart of a process for using machine learning in the applicant selection processes shown in FIGS. 3 and 4.

### DETAILED DESCRIPTION OF THE DISCLOSURE

The following detailed description illustrates embodiments of the disclosure by way of example and not by way of limitation. It is contemplated that the disclosure has general application to selecting applicants for participation in a program.

The systems and methods described herein relate to selecting applicants for participation in a program. More specifically, the systems and methods described herein are configured to a selection process to facilitate choosing participants who are most likely to succeed at a program that enables such participants to earn a wage and work their way out of poverty.

The International Poverty Line is a maximum amount of money that a person can make a day and still be considered to be living in poverty. When this application was written, in 2008 the International Poverty Line was set at US$1.25 a day. In 2015, the World Bank updated the International Poverty Line to US$1.90 a day. The World Bank calculates the International Poverty Line to correspond to the same level of welfare, regardless of the country the individual lives in. The International Poverty Line is calculated based on the national poverty lines from 15 of the poorest countries in the world adjusted for the purchasing power parity exchange rates for each country. Therefore, an individual currently living in poverty would be living on less than US$1.90 a day.

While in some contexts it may seem harsh to provide certain types of aid only to a select group of applicants living in poverty, to achieve the mission of providing assistance to lift people out of poverty, numerous realities have to be considered, including the reality that charitable organizations have limited resources. Determining the criteria to use, and then actually applying those criteria through interviews with numerous applicants, can be time consuming, burdensome, and without the correct criteria and appropriate interviewing and screening, likely ineffective.

Given the realities, including the difficulty in having meaningful communications with those living in poverty in at least some parts of the world, many charitable organizations are not overly selective when choosing to whom they provide assistance. However, when serving a mission to provide assistance to lift people out of poverty such lack of selectivity can result a depletion of the organizations resources without achieving the mission. Further, determining how to select participants in such a program can be extremely difficult and time consuming.

An organization could be more effective if it could direct its assistance and resources to those who would be the most successful both in the program and afterwards. Choosing those who are most likely to succeed can result in more of a positive impact on the local economy, rather than just spreading resources around. However, many organizations do not take the time or expend the effort to interview poor people in developing countries. Providing temporary relief or focusing on a specific circumstance or geographic area is easier for the organization, even if this approach may not achieve the organization's goals in the long run.

While many people want to participate in a program to help get themselves out of poverty, resources are finite. By helping those most likely to succeed in a program, the successful applicant's increased prosperity works to ripple out and help others in the community. To that end, the selection process narrows down a large pool of applicants quickly, efficiently, and effectively. For the purposes of this application, a large pool of applications may include forty or more applicants. To this extent, an Applicant Selection (AS) computing device is configured to rate the applicants based on each applicant's responses to questions.

In the example embodiment, an examiner interviews applicants from a pool of applicants for the program. During each interview, the AS computing device prompts the examiner to ask the applicant a series of questions stored in a memory that is communicatively connected to the AS computing device. The examiner enters each answer into the AS computing device, which stores the answer and assigns the answer a pre-determined value based on a table of possible answers and associated values. The AS computing device applies the assigned value to the score for the applicant. As the examiner asks more questions and receives answers, the AS computing device determines the values associated those answers and applies those determined values to update the applicant's score. At the end of the interview, the applicant is given a preliminary score and a ranking among the other applicants in the applicant pool. The AS computing device is configured to prompt the examiner to ask the applicant questions concerning three major categories: income, expenses, and intangible qualities. In the first category, the AS computing device evaluates the applicant's income, the income of the applicant's family, and any additional aid or income that the applicant receives. The AS computing device compares the applicant's income to that of the other applicants, assigns values to the applicant's score based on how the applicant's income compares to the other applicants, and calculates a total income score for the applicant. In evaluating expenses, the AS computing device counts the number and types of dependents that the applicant is responsible for, as well as school fees and other expenses to calculate a total expenses score for the applicant.

After evaluating income and expenses, the AS computing device may combine the applicant's total income score with the applicant's total expenses score to calculate a total need score for the applicant.

The AS computing device also evaluates the intangible qualities of the applicant, which are not as easily quantifiable as those in the other two categories. In the example embodiment, the examiner determines if the applicant has entrepreneurial spirit, weaving ability, and/or appropriate behavior for certain criteria for the applicant's region. These qualities are not all required for an applicant to succeed in the program, but the more of these qualities that an applicant has, the more likely the applicant is to be successful in the program and exit poverty. The examiner enters these determinations in the AS computing device. For select qualities possessed by an applicant, a pre-determined value associated with that quality is utilized in determining the applicant's score.

The AS computing device, also allows the examiner to include his or her personal perceptions of the applicant. If the examiner believes that the applicant has a very good chance of success in the program, then the examiner can enter a wildcard indicator into the AS computing device. When the wildcard indicator is received, the AS computing device applies a pre-determined value to the applicant's score. This pre-determined value is used to counteract for deficiencies in other areas of the applicant's score.

At the end of the interview, the AS computing calculates a preliminary score for the applicant by combining all of the values associated with the applicant's answers. Next the AS computing device calculates a preliminary rank for the applicant by comparing the applicant's preliminary score against the preliminary scores of the rest of the applicants. These ranks facilitate the selection of applicants from the applicant pool for the program.

In this embodiment, after the interview, the examiner follows up with the highest scoring applicants by visiting the applicant at his or her home. At this interview, the examiner may use the AS computing device to check the honesty of the applicant's answers in the interview by reviewing the stored answers against only investigations that the examiner performs. If the examiner discovers that an applicant has been intentionally dishonest in terms of assets, dependents, or in any way, the dishonest applicant is immediately removed from the selection process. The home visit also allows the examiner to adjust the rankings of the applicants. If there is only one spot left in the program and there are two applicants whose scores are very close, a home visit may allow the examiner to choose between the two applicants. As a result of the home visit, the examiner may change one or more of the applicant's answers. After these adjustments from the home visits, the AS computing device calculates the final scores using the assigned values and then uses the final scores to calculate the rankings for each applicant to enable selecting which applicants to admit to the program.

In the exemplary embodiment, the values and weights used to evaluate the applicants are based on the performance of previous applicants. To ensure that the best quality applicants are chosen for the program, the AS computing device analyzes the performance of previous applicants in the program to determine which attributes are more important to the success of applicants than others. The performance of previous application data includes the attributes of the applicants based on their answers to the questions in the interview process, their individual performance in the program, and their performance after the program. The AS computing device uses this information to generate one or more models of the applicant selection process and determines weights for the different attributes to improve the process of ranking the applicants to be selected for the program.

Other information gained from the analysis of previous applicants includes which different types of business are more successful, which combinations of businesses seem to work well together, and/or when different businesses were started. This other information can be used to improve the program itself, by allowing the participants in the program to know which businesses and combinations of business have a higher chance of success based on the applicant's attributes. This will allow the program leaders to instruct the participants on which businesses to start based on their individual current situation. The timing information can also be used to predict when participants are having trouble.

The methods and systems described herein may be implemented using computer programming or engineering techniques including computer software, firmware, hardware, or any combination or subset wherein a technical effect of the systems and processes described herein is achieved by performing at least one of the following steps: (a) providing an applicant selection computing device in communication with a memory; (b) storing, in the memory, a plurality of questions to ask an applicant to a charity program; (c) storing, in the memory, a plurality of ratings based on historical data wherein the ratings are used to calculate the applicant's likelihood of success in the charity program; (d) compiling, by the computing device, one or more scores for the applicant based on the applicant's answers to the plurality of questions and the plurality of ratings, the one or more scores including: (d1) an income score, which is based on the current income of the applicant including the income for the applicant and the applicant's family members and any aid the applicant is receiving from other sources; (d2) an expenses score, which is based on the current expenses of the applicant including number of dependents and school fees; and (d3) an intangibles score, which is based on the applicant's intangible qualities, including spirit, artisan ability, and behavior; (e) calculating, by the computing device, the applicant's overall score based on the one or more scores; (f) determining the applicant's ranking in comparison to one or more applicants for the charity program; (g) modifying the applicant's overall score based on the results of a visit to the applicant's home; and (h) outputting the rankings of the applicants to the charity program.

In one embodiment, a computer program is provided, and the program is embodied on a computer readable medium. In an example embodiment, the system is executed on a single computer system, without requiring a connection to a server computer. In a further example embodiment, the system is run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

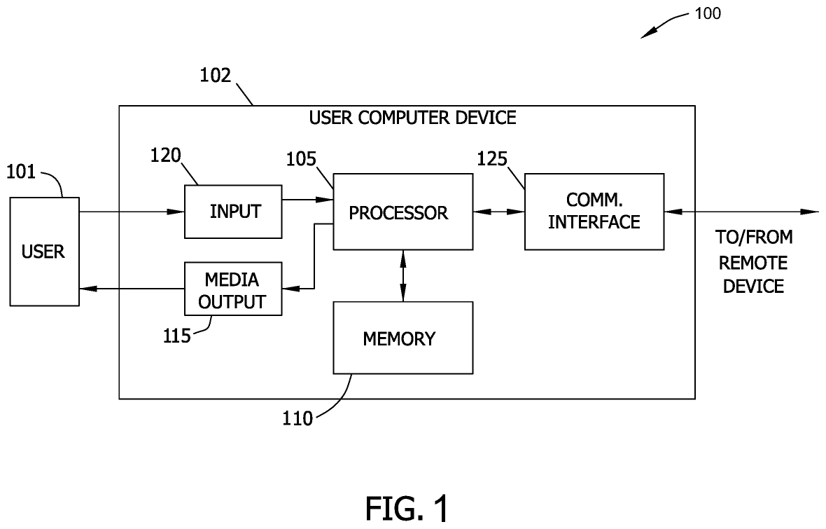

FIG. 1 is a block diagram of an exemplary computing device 100. The generic computing device 100 represents various forms of digital computers, such as laptops, desktops, workstations, personal digital assistants, servers, blade servers, mainframes, tablets, and other appropriate computers. Computing device 100 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

User computer device 102 is operated by a user 101. User computer device 102 includes a processor 105 for executing instructions. In some embodiments, executable instructions are stored in a memory area 110. Processor 105 may include one or more processing units (e.g., in a multi-core configuration). Memory area 110 is any device allowing information such as executable instructions and/or transaction data to be stored and retrieved. Memory area 110 may include one or more computer readable media.

User computer device 102 also includes at least one media output component 115 for presenting information to user 101. Media output component 115 is any component capable of conveying information to user 101. In some embodiments, media output component 115 includes an output adapter (not shown) such as a video adapter and/or an audio adapter. An output adapter is operatively coupled to processor 105 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 115 is configured to present a graphical user interface (e.g., a web browser and/or a client application) to user 101. A graphical user interface may include, for example, an online store interface for viewing and/or purchasing items, and/or a wallet application for managing payment information. In some embodiments, user computer device 102 includes an input device 120 for receiving input from user 101. User 101 may use input device 120 to, without limitation, select and/or enter one or more items to purchase and/or a purchase request, or to access credential information, and/or payment information. Input device 120 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 115 and input device 120.

User computer device 102 may also include a communication interface 125, communicatively coupled to a remote device. Communication interface 125 may include, for example, a wired or wireless network adapter and/or a wireless data transceiver for use with a mobile telecommunications network.

Stored in memory area 110 are, for example, computer readable instructions for providing a user interface to user 101 via media output component 115 and, optionally, receiving and processing input from input device 120. A user interface may include, among other possibilities, a web browser and/or a client application. Web browsers enable users, such as user 101, to display and interact with media and other information typically embedded on a web page or a website. A client application allows user 101 to interact with, for example, a server system. For example, instructions may be stored by a cloud service, and the output of the execution of the instructions sent to the media output component 115.

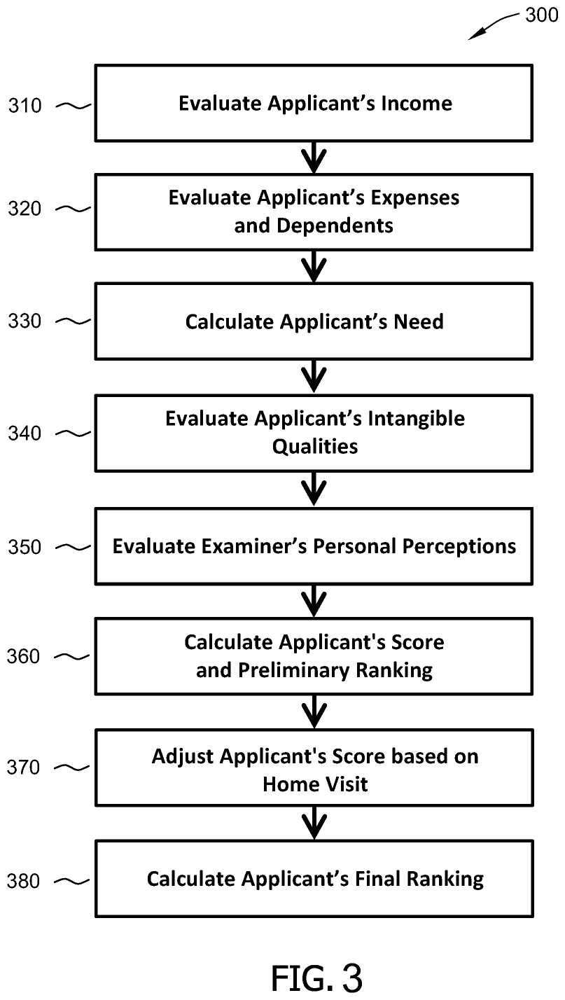

Processor 105 executes computer-executable instructions for implementing aspects of the disclosure. In some embodiments, the processor 105 is transformed into a special purpose microprocessor by executing computer-executable instructions or by otherwise being programmed. For example, the processor 105 can be programmed with the instruction such as illustrated in FIG. 3.

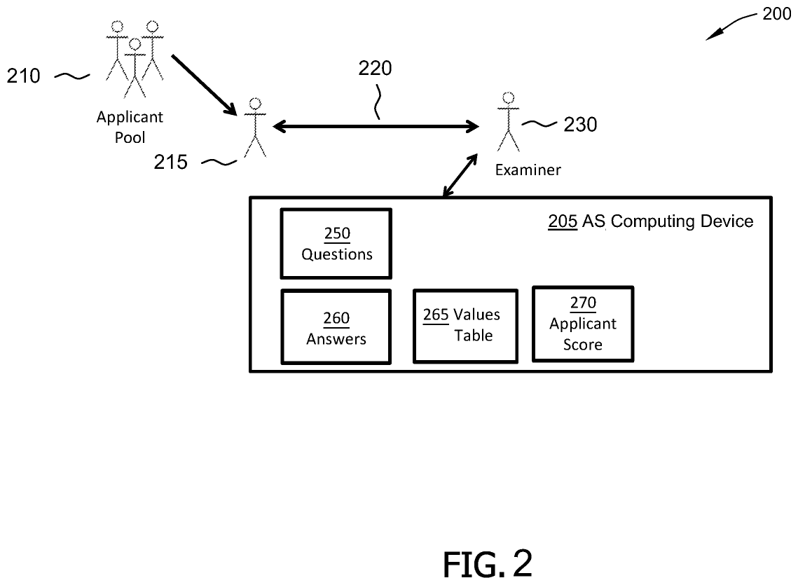

FIG. 2 is a block diagram of the process of interviewing 200 an applicant 215. In this example, the applicant 215 is chosen from a pool of applicants 210 to interact 220 with an examiner 230. The examiner 230 may be a single person or multiple people. In this embodiment, the interaction 220 between the examiner 230 and the applicant 215 is face-to-face. In other embodiments, the interaction 220 between the examiner 230 and the applicant 215 may be through other forms of communication such as over a phone or via video chat on the computer; however, face-to-face communication generally provides a robust venue for the examiner 230 to directly observe the applicant 215.

The examiner 230 uses an applicant selection (AS) computing device 205 during the examination 200. The AS computing device 205 is similar to the computing device 102 shown in FIG. 1. The AS computing device 205 includes a database having questions 250 stored therein, a listing of each applicant's answers 260, a values table 265, and a score 270 associated with each applicant 215. The database of questions 250 contains questions for the examiner 230 to ask to the applicants 215. These questions may be stand-alone or may be chains of questions, including follow-up questions. The database of questions 250 also includes questions to the examiner 230 about the examiner's observations of the applicant 215. In this embodiment, the questions are divided into three main categories: income, expenses, and intangible qualities.

The values table 265 contains one or more potential answers for each question in the database of questions 250 and values for each of these answers. Some of the values from the values table 265 may be pre-determined, while others may be calculated by the AS computing device 205. When an answer is received, the AS computing device 205 stores the answer in the answer listing 260 for that applicant 215 and then references the values table 265 to retrieve the value associated for that particular answer. The AS computing device 205 then applies the retrieved value to the score 270 for the applicant 215.

In one embodiment, the interview process may proceed as follows. The AS computing device 205 retrieves a question from the question database 250. The AS computing device 205 displays the question to the examiner 230 so that the examiner 230 may ask the question to the applicant 215. When the applicant 215 responds to the question, the examiner 230 enters the applicant's answer 260 into the AS computing device 205. Then the AS computing device 205 stores the answer in the applicant's answer listing 260, compares the answer 260 to the values table 265 to retrieve the value for that answer 260, applies the retrieved value to the applicant's score 270, and stores the result in the memory area 110. Next, the AS computing device 205 retrieves and displays another question from the question database 250 for the examiner 230. When the interview is complete, the AS computing device 205 calculates the applicant's score 270 based on the values of the applicant's answers and displays that applicant's score 270 to the examiner 230. The interview process is repeated for each applicant 215 in the applicant pool 210.

FIG. 3 is a high-level overview flowchart of the process 300 for selecting applicants in accordance with one embodiment of this disclosure. First, the AS computing device 205 evaluates the applicant's income 310 through a series of questions asked to the applicant 215. Each of the applicant's answers is assigned a value from the values table 265. Then a total income score is calculated for the applicant's income based on the values from the applicant's answers. In the example embodiment, these questions may include the applicant's personal income, the income of the applicant's family members, and any aid or other income that the applicant 215 is receiving. In this embodiment, the values for the applicant's income are based on the applicant's income compared to the other applicants' incomes. The AS computing device 205 may update the income values for all of the applicants every time that another applicant is interviewed. In other embodiments, the income values may be updated once all of the interviews are complete. For example, Applicant A may respond to a question that she receives no aid for school fees. After the examiner 230 enters her answer in the AS computing device 205, the AS computing device 205 assigns that answer a 0 value. Then Applicant A is then asked what her monthly income is and any other monthly family income she may have, to which she replies 4000 of the local currency for herself and 1000 for her family. After this information has been entered, the combined income is compared to the combined income of all of the applicants in the applicant pool 210. If the applicant's combined income is in the top quarter then a 7 is assigned, if in the second quarter a 6, in the third quarter a 4, and in the bottom quarter a 3. The aid for school fees and other income values, if any, would be added in as well. In this case, Applicant A is in the third quarter and the AS computing device 205 calculates her total income score to be a 4.

Through another series of questions the AS computing device 205 evaluates the applicant's expenses and dependents 320. The answers to these questions are assigned values from the table of values 265. Then the AS computing device 205 calculates a total expenses score based on the assigned values. Questions may include the number and type of dependents that the applicant 215 has, school fees that the applicant 215 is required to pay, or other potential expenses. For example, the Applicant A is asked how many dependent children she has. She replies 2. The examiner 230 enters the numbers into the AS computing device 205. The AS computing device 205 stores the number and assigns the answer a value of 2, or 1 per dependent child. Applicant A is next asked the number of elderly dependents that she is responsible for, to which Applicant A replies 1. The AS computing device 205 assigns that answer a value of 1 as well. When Applicant A is asked about the number of adult dependents, she replies 0, and the AS computing device 205 keeps the value at 0. Next Applicant A is asked how many of her dependents are sick, to which Applicant A answers 2. For each sick dependent, the AS computing device 205 applies another 0.5 to Applicant A's expenses score. After finding out that Applicant A is responsible for 2 sets of schools fees (assigning another 1 to the score for each school fee that is not covered by outside aid) and has no other expenses, the AS computing device 205 calculates the Applicant A's total expenses score to be 6, i.e., 2 for the dependent children, plus 1 for the elderly dependent, plus 1.0 for the two dependents that are sick, plus 2 for the school fees, equals a total expenses score of 6.

The AS computing device 205 uses the applicant's total income score and total expenses score to calculate the applicant's need 330. In the above example, the AS computing device 205 subtracts the applicant's total income score from the applicant's total expenses score. Next the AS computing device 205 subtracts the above difference from 10. The result is the applicant's total need score. In Applicant A's case, her total income score was a 4 and her total expenses score was a 6. This gives her a total need score of 10−(4−6)=12.

Next the AS computing device 205 evaluates the applicant's intangible qualities 340. Each applicant 215 has many different qualities that may contribute to his or her potential for success in the program; however, these skills cannot be quantified as neatly as the applicant's income. In this embodiment, the intangible properties of the applicant 215 are based on the observations of the examiner 230. In this case, the intangible qualities that the examiner 230 is evaluating the applicant 215 for are spirit, weaving ability, and behavior. The examiner 230 enters on the AS computing device 205 if the applicant 215 possesses each quality. The AS computing device 205 assigns a value to the presence or absence of each quality. For spirit, the examiner 230 looks at the applicant 215 for proven or implied entrepreneurial activity, in other words entrepreneurial spirit. For weaving ability, the applicant 215 is tested to see if he or she can weave at the standards for the program. The criteria for behavior are very country-specific. For example, women in one country may be culturally divisive and non-supportive of each one another. The examiner 230 would be looking for women that are non-divisive and helped their neighbors, a rare quality in women from that particular country. If any applicant has a strong positive reputation that precedes him or her from his or her village, the examiner 230 would enter into the AS computing device 205 that the applicant met the desired criteria for the behavior quality. While in this embodiment the presence of these qualities is being tested, in other embodiments the quantity of these qualities could be tested. For example, weaving ability could be evaluated on a scale rather than a yes or no. When entered into the AS computing device 205, the presence or absence of each of these qualities is assigned a different value. In Applicant A's case, the AS computing device 205 may assign a 3 if she meets the criteria for spirit, a 1 if she has weaving ability, and a 2 if she meets the criteria for behavior.

The next item entered into the AS computing device 205 is a wildcard indicator, where the examiner 230 evaluates 350 his or her personal perceptions of the applicant 215. There are qualities of an applicant 215 that defy the examination process, where the examiner 230 feels, that despite what the numbers say, a particular applicant 215 has a very good chance of succeeding in the program. The wildcard indicator may be used when the applicant 215 does something that shows a strong spirit or boldness. In one embodiment, if Applicant A sits down at the interview and rather than speaking only to the examiner 230, who speaks the local language, speaks directly to the out-of-country team that is observing, that may indicate a strong spirit or boldness. Although neither group speaks the other's language, the fact that Applicant A is uninhibited and bold enough to talk directly to the out-of-country team earns her the wildcard indicator. When the examiner 230 enters the wildcard indicator into the AS computing device 205, the AS computing device 205 assigns a value to offset deficiencies in other areas of the examination. This allows for applicants 215 who would otherwise be passed to be given a chance if the examiner 230 has the impression they are likely to succeed in the program. In this embodiment, the wildcard indicator is limited by the observations of the examiner 230.

Next the AS computing device 205 compiles all of the values in a formula to calculate 360 the score 270 for the applicant 215. This score 270 assists the examiner 230 in determining if the applicant 215 is likely to succeed in the program. Then the score is compared to the scores of all of the other applicants in the applicant pool 210 to determine the applicant's preliminary ranking. The rankings facilitate selecting applicants for participation in the program. For example, Applicant A has a total need score of 12. To the total need the AS computing device 205 applies the values for possessing spirit (3), weaving ability (1), and the wildcard (3) for a total score 270 of 19. In this embodiment, this total score 270 is extremely high, so the applicant 215 is likely to be highly ranked and be accepted into the program.

After the interview, the examiner 230 follows up with the applicant 215 by visiting the applicant's home. This home visit allows the examiner 230 to adjust the applicant's score 270 and/or ranking 370. In some cases, two or more applicants may be tied or have a score difference of only one point. In deciding which applicants to accept to the program, a home visit gives the examiner 230 more information. The home visit also allows the examiner 230 to evaluate the applicant's honesty in his or her answers. The home visit is also helpful in deciding if the applicant 215 deserves the wildcard indicator. On a home visit an examiner 230 may be able to compare the applicant's answers from the AS computing device 205 with the evidence presented before the examiner 230. For example, Applicant A has been the highest ranked applicant in the interview part of the process. But when the examiner 230 visits Applicant B's home, the examiner 230 discovers that Applicant A owns a sizeable piece of land that the applicant 215 is not using. This discovery leads the examiner 230 to check the truthfulness of Applicant A's other answers. At this point, the Applicant A has shown that she is not using her resources to their best potential, thus leading the examiner 230 to have serious doubts about Applicant A's ability to succeed in the program. Applicant's A ranking may be lowered. If the examiner 230 discovers that Applicant A was not honest with the examiner 230 then Applicant A would be dismissed from the selection process. In a different example, Applicant B has a tiny area of land that she owns, but uses the land very effectively to grow as many vegetables as possible. This may indicate to the examiner 230 that Applicant B has a high probability of succeeding in the program.

After the home visits, the AS computing device 205 calculates the applicants' final rankings 380. Space in charity programs is limited and resources are finite, so it is important to take the highest ranked applicants, the most likely to succeed.

While the above embodiment listed specific values and formula to calculate the applicant's score 270, in other embodiments, other values or formulas may be employed. In some embodiments, values and formulas may be updated based on historical data or based on differences in regional locations.

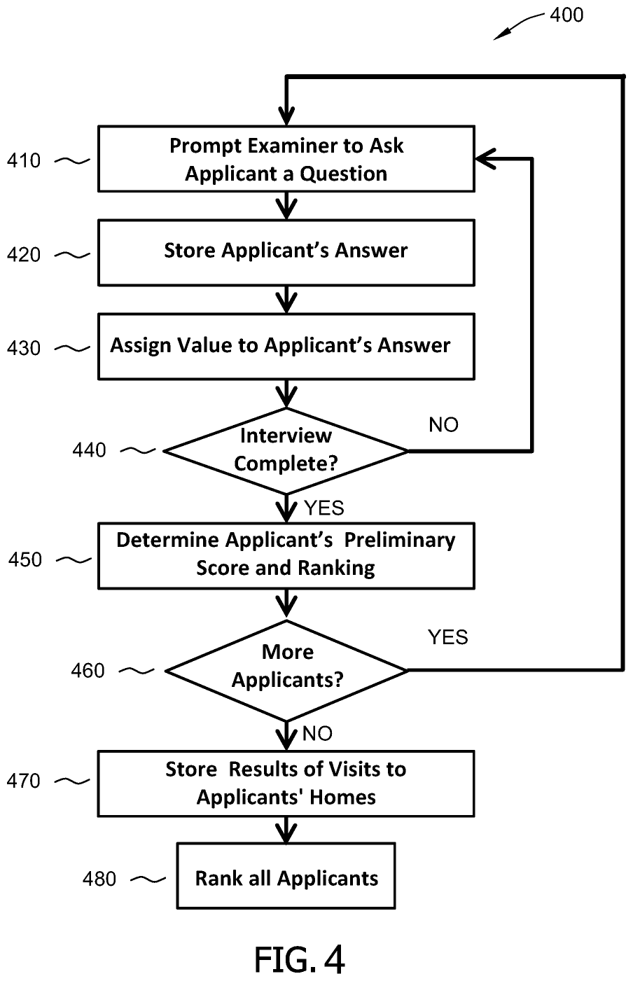

FIG. 4 is a detailed flowchart of the interaction 400 between the AS computing device 205 and the examiner 230 during the selection process. The AS computing device 205 prompts 410 the examiner 230 to ask the applicant 215 a question from the database of questions 250 that the AS computing device 205 has stored in the memory area 110. When the examiner 230 gets an answer to the question, the examiner 230 enters that answer into the AS computing device 205 using the user input interface 120. The AS computing device 205 stores the answer 420 in the applicant's answer listing 260 and then assigns the answer a value 430 based on the value table 265 (as shown in FIG. 2).

The AS computing device 205 then checks to see if the interview is complete 440. In some embodiments, the AS computing device 205 receives an indicator from the examiner 230 noting the completion of the interview. In other embodiments, the AS computing device 205 monitors the questions being answered and concludes the interview after a pre-determined last question has been answered. If the examination is not complete, then the AS computing device 205 prompts 410 the examiner 230 to ask a different question from the question database 250. Otherwise the AS computing device 205 determines the applicant's preliminary score 270 (based on the values of the applicant's answers) and ranking 450 (based on a comparison of the scores of the other applicants). To calculate the score 270, the AS computing device 205 applies the values associated with the applicant's answers to a formula to determine a numerical score.

The AS computing device 205 checks to see if there are still more applicants to interview 460. In some embodiments, the AS computing device 205 receives a list of the applicants to be interview. If there are more applicants, then the AS computing device 205 goes back to step 410 and prompts the examiner 230 to ask a question to the next applicant 215. Otherwise, the AS computing device 205 next stores the results of the examiner's visits to the applicants' homes 470. Once the home visits are complete, the AS computing device 205 ranks all of the applicants for the program 480.

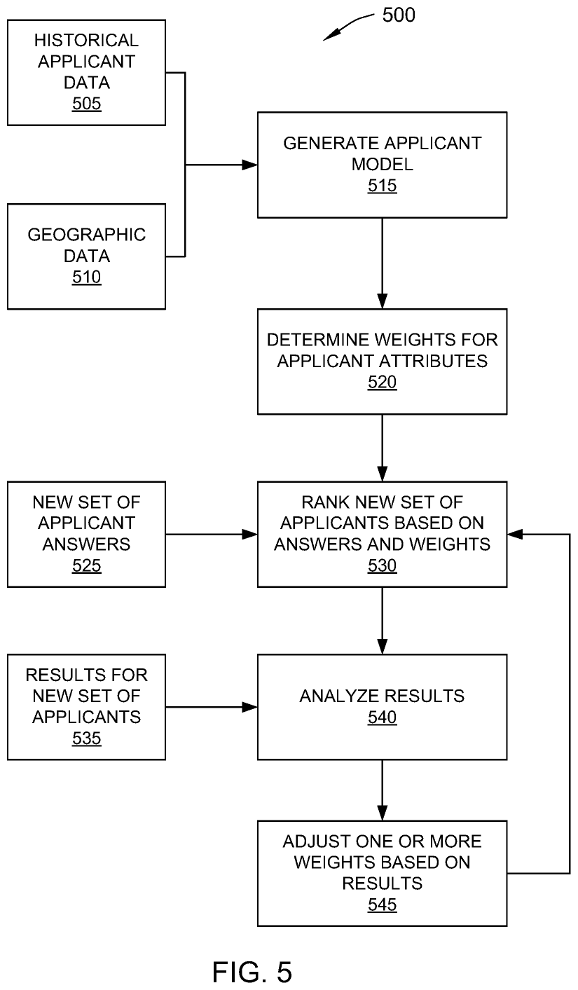

FIG. 5 is a detailed flowchart of a process 500 for using machine learning in the applicant selection processes 300 and 400 (shown in FIGS. 3 and 4, respectively). In the exemplary embodiment, process 500 is performed by AS computing device 205 (shown in FIG. 2).

In the exemplary embodiment, a plurality of historical applicant data 505 is provided to the AS computing device 205. The plurality of historical applicant data 505 includes answers provided by previous applicants to the program. The plurality of historical applicant data 505 also includes data about how the applicants fared in the program. For example, what types of businesses did they open, when did they open the businesses, did the applicants successfully move out of poverty, how far into the program did the applicants graduate from the program, and is the applicant still successful a period of time after graduating from the program.

In some embodiments, geographic data 510 is also provided to the AS computing device 205. The geographic data 510 includes information about the geographic area where the applicants are from. This can include information about whether or not there are individualized attributes for applicants from different geographic regions. For example, do the applicants have to pay school fees for their dependents and other attributes that can be specific to a particular region. This can also include pricing information such as average local costs for livestock, such as for goats, cows, and chickens.

In the exemplary embodiment, the AS computing device 205 generates 515 one or more applicant models. The applicant model(s) simulate the performance of different applicants and/or participants in the program based on their attributes. The AS computing device 205 uses the model(s) to determine details about an applicant based on their answers 260 to the questions 250 (both shown in FIG. 2) in the interview. For example, based on the number of children and amount of land that an individual applicant has, the model can be used to determine which individual businesses have the highest degree of success for that applicant. Furthermore, the model can also determine a likelihood that an applicant may succeed in the program to lift them up from poverty.

In the exemplary embodiment, the AS computing device 205 uses the model to determine 520 weights for the applicant attributes. For example, the model can determine that having children of different ages can be a help and/or a hindrance for different types of businesses or that applicants with specific attributes have a higher likelihood of success in the program. These weights can then be used in processes 300 and 400 to assist in the ranking of the applicants.

In the exemplary embodiment, the AS computing device 205 receives a new set of applicant answers 525, such as from answers 260. The AS computing device 205 uses the weights and the new set of applicant answers 525 to rank 530 the new set of applications. In some embodiments, the AS computing device 205 receives the new set of applicant answers 525 individually as the applicants are being interviewed. In other embodiments, the AS computing device 205 receives the new set of applicant answers 525 all at once or in batches, such as from being transferred from a different AS computing device 205. Furthermore, the AS computing device 205 is capable of dynamically re-ranking the new set of applicants based on changes to the answers 260. For example, the AS computing device 205 can dynamically rank 530 the applicants after each applicant has finished answering the questions 250. In other examples, the AS computing device 205 calculates each applicants score and preliminary rank, as shown in step 360 (shown in FIG. 3). When the AS computing device 205 receives the data from the home visit, the AS computing device 205 adjusts 370 the applicant's score and calculates 380 the updated ranking for the applicant. The ranking is in comparison to the other applicants.

In the exemplary embodiment, the AS computing device 205 receives results 535 for the new set of applicants that were selected as participants in the program. The results data can include, but is not limited to, how the participants performed in the program, their income at different points in time, the businesses that they opened, how those businesses performed, and when they graduated from the program. The AS computing device 205 analyzes 540 the results 535 and compares the results 535 to the model(s). Then the AS computing device 205 adjusts 545 one or more of the weights of the model based on the results 535. These adjusted weights are integrated into the model and used in analysis of future applicants.

Furthermore, the model(s) can be used to analyze the performance of active participants in the program. If a participant is lagging behind the others, or is having problems, the model can detect these issues and alert the leaders of the program to help to assist the struggling participants. Furthermore, the model can be used to match up applicants with different types of businesses to help them and increase their likelihood of succeeding in the program. For example, if participant has a lot of land of a sufficient size, the model can suggest one or more businesses or streams of income that the participant could start, such as purchasing chickens for their eggs.

As the AS computing device 205 analyzes the historical applicant data 505 of the businesses program that previous participants have stated, the AS computing device 205 looks for associations between business types as compared to those who successfully graduate the program. Using learning associations, the AS computing device 205 and the model(s) can recommend to participants what types of businesses have proven successful for their colleagues and make recommendations on types of businesses which might work for them based on what has worked for participants who have a similar set of starting statistics; for example; number and age of children, size of available land.

The AS computing device 205 can also associate the amount earned to the possibility of businesses for the participants. If the participant weaves three of item A and two of item B and thus earns X amount, the AS computing device 205 can associate all possible business which can be started with X amount and recommend one or more of those businesses to the participant.

If the participant has purchased cows, the AS computing device 205 and model(s) can also ask follow-up questions to determine if the participant is also renting out those cows for field plowing, if the participant is selling the milk, if the participant is breeding the cows, or if the participant is raising and selling the cows for meat. This would allow the AS computing device 205 to better track the participant's potential income. In some embodiments, the AS computing device 205 can recommend one or more of these business uses for the cows to the participant to give them additional options and/or income streams from the cows.

As the AS computing device 205 generates 515 the model, determines 520 the weights, and adjusts 545 the weights, the AS computing device 205 is using machine learning to look for and recognize associations within the data. These associations can include the timeframe in which first business was started as compared to ultimate program success for the participants. This timeframe can be used to recommend new requirements for the program and/or benchmarks to review the performance of participants for the program, thereby increasing the chance of success for the participant. For example, if the AS computing device 205 determines that participants who start businesses within the first two years are more likely to graduate from the program. The AS computing device 205 can determine and notify program leaders when a participant is behind the curve and may need special attention to graduate.

The associations can also include the type and number of businesses started as compared to program success. This means over time, the AS computing device 205 can extract what types of businesses are more likely to lead to success. This information can fuel the learning associations data in the model and what it recommends to participants, thereby increasing the chance of successful graduation for participants.

In another example, every participant could be identified by one or more of their stored photo, a photo scan of their signature, and a bar code which includes the participants identity number. Associated with every image, signature and bar code identifier for the participant could be a bar code identifying every single product that the participant makes. These unique product identifiers allow the AS computing device 205 to track that very product that the participant made throughout its entire journey from the participant's hand to the consumer. When the consumer learns more about the participant by seeing their face, their signature and their product linked to the profile, the consumer is more likely to purchase those products—thereby hastening the participant's journey out of poverty.

In the exemplary embodiment, process 500 can include classification, where classification is a process of placing each individual under study in many classes. Classification can be used to analyze the measurements of an object to identify the category to which that object belongs. One example of classification would be where the AS computing device 205 uses the number of businesses associated with the participant to determine the likelihood for participation in the program and the likelihood to graduate.

Another example of classification could be the participant selection processes 300 and 400. The processes 300 and 400 classify the information of a group of people. The AS computing device 205 assess the wealth of that group of people and chooses the poorest and the most entrepreneurial among the group to be program participants.

The AS computing device 205 analyzes successful participants by looking at their attributes, such as, but not limited to, number of children, type and number of businesses, total income earned. From that analysis, the AS computing device 205 can analyze of those attributes in country A and update the weights for country B to help ensure participants in country B have a better chance of success based on the analysis of Country A. This is particularly helpful where countries are regional. For example, what is working in Ghana, is likely to work in neighboring Togo.

In another embodiment, the AS computing device 205 analyzes the historical application data 505 of the businesses that the program participants start. The AS computing device 205 looks for associations between business types as compared to those who successfully graduate. Using learning associations, the AS computing device 205 can recommend to participants what types of businesses have proven successful for their colleagues and make recommendations on types of businesses which might work for them based on what has worked for participants who have a similar set of starting attributes; for example, but not limited to, number and age of children, and size of land.

For example, if a participant from Ghana is selected and enrolls in the program, the AS computing device 205 determines how many children the participant has and their ages based on the participant's answers 260. The AS computing device 205 cross-references those answers 260 with historical graduates from Ghana with the same number of children and with similar ages. The AS computing device 205 determines which businesses were chosen and successful for the historical graduates with similar attributes and suggests those businesses to the participant as information to consider. In some embodiments, the businesses are presented with additional information, such as, but not limited to, what percentage of similar graduates chose each business, how much it would cost to start, how much income the business could bring in, other businesses that would complement the business, and what it would take to maintain and run the business. This information can then help the applicant to choose their business.

In another example, if the program is being expanded into other countries, then the AS computing device 205 can provide information about weights and businesses in similar counties. This helps start the process and the model for a new country and will be updated as time passes and participants graduate from the program.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, applicant data, national and cultural data, and telematics data. ML outputs may include but are not limited to: digital signals (e.g. information data converted from natural phenomena). ML outputs may further include: speech recognition, image or video recognition, medical diagnoses, statistical or financial models, autonomous vehicle decision-making models, robotics behavior modeling, fraud detection analysis, network routing decision, user input recommendations and personalization, game AI, skill acquisition, targeted marketing, big data visualization, weather forecasting, applicant analysis, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising data associated with previous applicants and their results in the program, generate a model which maps the attributes of the applicant to data about how the applicant performed in the program, and generate predictions of what attributes may indicate success in future applicants based on current data. In another example, a further ML module may receive training data comprising historical weighting information, generate one or more models that maps the accuracy of the received weighting information, and generate predictions about the accuracy of new weighting information in view of those models.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data comprising event data, financial data, social data, geographic data, cultural data, and political data, and the ML module employs an unsupervised learning method such as “clustering” to identify patterns and organize the unlabeled data into meaningful groups. The newly organized data may be used, for example, to extract further information about the potential applicant performance.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

In some embodiments, the ML module may determine that using one or more variables in one or more models are unnecessary in future iterations due to a lack of results or importance. Furthermore, the ML module may recognize patterns and be able to apply those patterns when executing models to improve the efficiency of that process and reduce processing resources. In some embodiments, ML modules may be executed on ML training computational units customized for ML training. For example, in some embodiments, tensor processing units (TPUs) may be used for ML training.

As will be appreciated based on the foregoing specification, the above-described embodiments of the disclosure may be implemented using computer programming or engineering techniques including computer software, firmware, hardware or any combination or subset thereof Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer device for selecting participants from an applicant pool to participate in a program to exit poverty, the computer device including a processor in communication with a memory, the memory including computer-executable instructions that, when executed by the processor, cause the processor to:
store, in the memory, a plurality of questions to ask each applicant currently living in poverty from a large pool of applicants currently living in poverty;
store, in the memory, a model based on historical applicant data, wherein the historical applicant data includes information about previous applicants and participants that have applied for and participated in the program to exit poverty, wherein the model is configured to determine an applicant's chances of success in the program to exit poverty and to determine information to improve the applicants' chances of success in the program to exit poverty;
for each applicant of the large pool of applicants, the instructions cause the processor to:
instruct a display device to display a graphical user interface including the plurality of questions to a user;
receive from the user via an input device, a plurality of responses to the one or more displayed questions, wherein the plurality of responses include responses associated with an income score, an expenses score, and an intangibles score;
compile an income score based on current income of the applicant in relation to a current income for each of the applicants, an expenses score based on current expenses of the applicant, and an intangibles score based on intangible qualities of the applicant based on the applicant's answers to the plurality of questions;
calculate a likelihood of the applicant successfully participating in the program to exit poverty based on the income score, the expenses score, and the intangibles score;
calculate the applicant's overall score based on the calculated likelihood of the applicant successfully participating in the program to exit poverty; and
dynamically determine the applicant's ranking in comparison to the large pool of applicants, based on each applicant's overall score; and
output, to the display device, the rankings of the applicants;
receive information about one or more applicants from the large pool of applicants who graduated from the program to exit poverty; and
update the model based on the received information about the one or more applicants who graduated from the program to exit poverty.

2. The computer device in accordance with claim 1, wherein the income score is based on the current income of the applicant and the applicant's family members.

3. The computer device in accordance with claim 1, wherein poverty is based on the International Poverty Line as defined by the World Bank.

4. The computer device in accordance with claim 1, wherein a large pool of applicants is greater than 40 applicants.

5. The computer device in accordance with claim 1, wherein the expenses score is based on the current expenses of the applicant including a number of dependents that the applicant has.

6. The computer device in accordance with claim 1, wherein the intangibles score is based on the intangible qualities of the applicant including at least one of entrepreneurial spirit, weaving ability, and behavior.

7. The computer device in accordance with claim 1, wherein the computer-executable instructions further cause the processor to modify the applicant's overall score based on the results of a visit to the applicant's home.

8. The computer device in accordance with claim 1, wherein the computer-executable instructions further cause the processor to:
receive and store an answer from the applicant;
compare the answer to a plurality of historical answers from a plurality of historical participants in the model; and
determine a weight for the answer based on the comparison.

9. The computer device in accordance with claim 1, wherein the model includes a plurality of weights, and wherein the computer-executable instructions further cause the processor to update at least one weight of the plurality of weights in the model based on the received information about the one or more applicants who graduated from the program to exit poverty.

10. A computer-implemented method for selecting participants from an applicant pool to participate in a program to exit poverty, the method implemented using a computer device in communication with a memory, the method comprising:
storing, in the memory, a plurality of questions to ask each applicant currently living in poverty from a large pool of applicants currently living in poverty;
storing, in the memory, a model based on historical applicant data, wherein the historical applicant data includes information about previous applicants and participants that have applied for and participated in the program to exit poverty, wherein the model is configured to determine an applicant's chances of success in the program to exit poverty and to determine information to improve the applicants' chances of success in the program to exit poverty;
for each applicant of the large pool of applicants, the method comprises:
instructing a display device to display a graphical user interface including the plurality of questions to a user;
receiving from the user via an input device, a plurality of responses to the one or more displayed questions, wherein the plurality of responses include responses associated with an income score, an expenses score, and an intangibles score;
compiling an income score based on current income of the applicant in relation to a current income for each of the applicants, an expenses score based on current expenses of the applicant, and an intangibles score based on intangible qualities of the applicant based on the applicant's answers to the plurality of questions;
calculating a likelihood of the applicant successfully participating in the program to exit poverty based on the income score, the expenses score, and the intangibles score;
calculating the applicant's overall score based on the calculated likelihood of the applicant successfully participating in the program to exit poverty; and
dynamically determining the applicant's ranking in comparison to the large pool of applicants, based on each applicant's overall score; and
outputting, to the display device, the rankings of the applicants;
receiving information about one or more applicants from the large pool of applicants who graduated from the program to exit poverty; and
updating the model based on the received information about the one or more applicants who graduated from the program to exit poverty.

11. The method in accordance with claim 10, wherein the income score is based on the current income of the applicant and the applicant's family members.

12. The method in accordance with claim 10, wherein poverty is based on the International Poverty Line as defined by the World Bank.

13. The method in accordance with claim 10, wherein a large pool of applicants is greater than 40 applicants.

14. The method in accordance with claim 10, wherein the expenses score is based on the current expenses of the applicant including a number of dependents that the applicant has.

15. The method in accordance with claim 10, wherein the intangibles score is based on the intangible qualities of the applicant including at least one of entrepreneurial spirit, weaving ability, and behavior.

16. The method in accordance with claim 10 further comprising modifying the applicant's overall score based on the results of a visit to the applicant's home.

17. The method in accordance with claim 10 further comprising:
receiving and storing an answer from the applicant;
comparing the answer to a plurality of historical answers from a plurality of historical participants in the model; and
determining a weight for the answer based on the comparison.

18. The method in accordance with claim 10, wherein the model includes a plurality of weights, and wherein the method further comprises updating at least one weight of the plurality of weights in the model based on the received information about the one or more applicants who graduated from the program to exit poverty.

19. A non-transitory computer-readable storage medium having computer-executable instructions embodied thereon, wherein when executed by a computing device having at least one processor coupled to a memory device, the computer-executable instructions cause the at least one processor to:
store, in the memory device, a plurality of questions to ask each applicant currently living in poverty from a large pool of applicants currently living in poverty;
store, in the memory device, a model based on historical applicant data, wherein the historical applicant data includes information about previous applicants and participants that have applied for and participated in the program to exit poverty, wherein the model is configured to determine an applicant's chances of success in the program to exit poverty and to determine information to improve the applicants' chances of success in the program to exit poverty;
for each applicant of the large pool of applicants, the instructions cause the at least one processor to:
instruct a display device to display a graphical user interface including the plurality of questions to a user;
receive from the user via an input device, a plurality of responses to the one or more displayed questions, wherein the plurality of responses include responses associated with an income score, an expenses score, and an intangibles score;
compile an income score based on current income of the applicant in relation to a current income for each of the applicants, an expenses score based on current expenses of the applicant, and an intangibles score based on intangible qualities of the applicant based on the applicant's answers to the plurality of questions;
calculate a likelihood of the applicant successfully participating in the program to exit poverty based on the income score, the expenses score, and the intangibles score;
calculate the applicant's overall score based on the calculated likelihood of the applicant successfully participating in the program to exit poverty; and
dynamically determine the applicant's ranking in comparison to the large pool of applicants, based on each applicant's overall score; and
output, to the display device, the rankings of the applicants;
receive information about one or more applicants from the large pool of applicants who graduated from the program to exit poverty; and
update the model based on the received information about the one or more applicants who graduated from the program to exit poverty.

20. The computer-readable storage media in accordance with claim 19, wherein the income score is based on the current income of the applicant and the applicant's family members, wherein the expenses score is based on the current expenses of the applicant including a number of dependents that the applicant has, wherein the intangibles score is based on the intangible qualities of the applicant including at least one of entrepreneurial spirit, weaving ability, and behavior, wherein poverty is based on the International Poverty Line as defined by the World Bank, wherein a large pool of applicants is greater than 40 applicants.
